(19) United States
(12) Patent Application Publication
(10) Pub. No.: US 2007/0098216 A1
(43) Pub. Date: May 3, 2007

(54) Method and system for FIFO image processing in a universal coding system

(76) Inventor: Kuldip K. Goyal, Alexandria, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/590,829

(22) Filed: Nov. 1, 2006

Related U.S. Application Data
(60) Provisional application No. 60/731,858, filed on Nov. 1, 2005.
(60) Provisional application No. 60/731,859, filed on Nov. 1, 2005.
(60) Provisional application No. 60/731,860, filed on Nov. 1, 2005.

(51) Int. Cl. G06K 9/00

(52) U.S. Cl. 382/101

(57) ABSTRACT

Methods and systems are disclosed for processing mailpieces. Images of mailpieces processed by a first mail processing device and a second mail processing device are captured. The images are stored in a coding system at a mail processing plant, and the images are sorted at the coding system according to time characteristics. The images are transmitted from the mail processing plant to a remote location. An encoding center at the remote location processes the images to obtain mail processing data from the images. Mail processing data is transmitted from the encoding center to the mail processing plant, and the mail processing devices process the mailpieces using the mail processing data from the encoding center. It is to be understood that both the foregoing general description and the following detailed description are exemplary and explanatory only and are not restrictive of the invention, as claimed.

### RELATED APPLICATIONS

This application claims the benefit of the filing date of U.S. Provisional Application No. 60/731,858, filed Nov. 1, 2005, titled “Method and System for Load Balancing Remote Image Processing in a Universal Coding System,” of Kuldip K. Goyal, David E. Williams, Brenda M. Weeks, Linda M. Malone, and Thomas Addams, incorporated in its entirety herein by reference.

This application also claims the benefit of the filing date of U.S. Provisional Application No. 60/731,859, filed Nov. 1, 2005, titled “Method and System for Image Processing Based on Product Type in a Universal Coding System,” of Kuldip K. Goyal, incorporated in its entirety herein by reference.

This application also claims the benefit of the filing date of U.S. Provisional Application No. 60/731,860, filed Nov. 1, 2005, titled “Method and System for FIFO Image Processing in a Universal Coding System,” of Kuldip K. Goyal, incorporated in its entirety herein by reference.

### TECHNICAL FIELD

This disclosure is directed to the field of processing delivery items. More particularly, this disclosure relates to methods and systems for processing mail and other delivery items within a universal coding system.

### BACKGROUND

Conventional systems for identifying and processing delivery items, including mailpieces, require both manual and mechanical operations. The manual operations are initially required to load the mail from a mail delivery repository into a mechanical identification and mail processing system. Mechanical operations then attempt to identify the delivery address for each mailpiece and, if successful, to then process each mailpiece based on the delivery address. Processing a mailpiece can be, for example, sorting the mailpiece, batching the mailpiece, applying a code to the mailpiece, etc. If there is a failure to identify the delivery address of a mailpiece mechanically, human operators are required again to identify the delivery address. Likewise, if there is a failure to process the mailpiece based on the delivery address, human operators are also required again to process the mailpiece. Therefore, conventional systems for identifying and processing mail depend on human operators if mechanical systems are unable to identify or process a mailpiece.

To identify mail in conventional systems, mail is loaded into a mechanical identification system, which automatically feeds each mailpiece into an optical character reader (OCR) machine. The OCR machine then attempts to electronically “read” the delivery address from the mailpiece in order to place the delivery address ZIP™ Code in a computer. If the OCR machine cannot read the delivery address (e.g., the ZIP™ Code), the mechanical device rejects the mailpiece. The rejected mailpiece may then be fed into another mechanical device, which presents the mailpiece to a human operator, who physically reads the delivery address off the mailpiece and enters the delivery address into a computer. Once the delivery address has been placed either electronically or physically into a computer, the computer prints delivery information on the mailpiece, using a special code (e.g., a bar code, such as a POSTNET code).

The majority of conventional mechanical processing systems sort each mailpiece based on a special code, such as a ZIP™ Code or POSTNET code. These mechanical processing systems may contain an optical character reader (OCR) that can read and sort a mailpiece based on its ZIP™ Code. These mechanical processing systems may also contain a Bar Code Sorter (BCS) function, which can read and sort a mailpiece based on the bar code such as the POSTNET code. If the mechanical processing system cannot read either the ZIP™ Code or the POSTNET code, the system rejects the mailpiece. The rejected mailpiece may then be processed by a human operator. The human operator may then determine why the mechanical processing system rejected the mailpiece, solve the problem (e.g., determine the ZIP™ Code or reaffix the POSTNET code to the mailpiece), and then reload the mailpiece into the mechanical processing system for processing.

To improve upon conventional systems for identifying and processing mail, the United States Postal Service developed an automated sorting system, described in U.S. Pat. No. 4,992,649 (the '649 patent). One embodiment of the system disclosed in the '649 patent is a Remote Bar Code System (RBCS). The embodiment of the RBCS described in the '649 patent provides for the electronic sorting of mail using a bar code that is placed on the front of each mailpiece, known as the POSTNET code, and another bar code that is placed on the back of each mailpiece, known as the identification tag (ID Tag).

In RBCS, the POSTNET code corresponds to the delivery address for the mailpiece, and the ID Tag corresponds to the unique identity of the mailpiece itself (i.e., the ID Tag code is a way to “identify” each particular mailpiece). The POSTNET code represents a copy of the ZIP™ Code in bar code format, and the POSTNET code can be used to route a mailpiece, if the ZIP™ Code cannot be read. The ID Tag represents a unique code in bar code format, and the ID Tag can be used to identify each particular mailpiece, if the RBCS cannot otherwise identify the mailpiece. For example, in the RBCS, the ID Tag can be linked to an electronic image of the mailpiece marked with the ID Tag and/or POSTNET code by the RBCS. So, if the RBCS cannot identify a mailpiece, the RBCS can recall the electronic image of the mailpiece, which contains a destination address, including the POSTNET code.

The identification and processing of mail in the RBCS is dependent upon the use of either the POSTNET code or the ID Tag. When each mailpiece is identified by the RBCS, the ID Tag is first stored temporarily until the mailpiece receives the POSTNET code and has been processed by the RBCS. If the POSTNET code becomes illegible during processing, the ID Tag may be used to obtain the POSTNET code. The ID Tag is used to store the POSTNET code in a short-term memory until the RBCS has processed the mailpiece based on the POSTNET code. However, once the mailpiece has been processed and sorted based on the POSTNET code, the RBCS can no longer access the ID Tag, because the RBCS cannot store unlimited ID Tags locally.

Thus, in certain situations, the POSTNET code cannot be read by the automated mail processing equipment. For instance, the POSTNET code on a mailpiece might be illegible as soon as it is applied due to the color or pattern of the mailpiece. If so, the mailpiece may be fed into a letter mail labeling machine that applies a white label to cover the illegible POSTNET code, and then, the mailpiece may be again fed into the RBCS for identification (and printing of a new POSTNET code on the white label). Additionally, the POSTNET code might be legible when applied, but become illegible during subsequent processing of the mailpiece. Because the ID Tag is only stored until the completion of the initial processing, the RBCS cannot use the ID Tag to identify the POSTNET code during subsequent processing and sorting. Therefore, if the POSTNET code becomes illegible during subsequent processing, the mailpiece can no longer be sorted automatically by the RBCS. This diminishes the efficiency of the systems for identifying and processing mail and requires excessive human intervention.

### SUMMARY

Methods and systems are disclosed for processing mailpieces. Images of mailpieces processed by a first mail processing device and a second mail processing device are captured. The images are stored in a coding system at a mail processing plant, and the images are sorted at the coding system according to time characteristics. The images are transmitted from the mail processing plant to a remote location. An encoding center at the remote location processes the images to obtain mail processing data from the images. Mail processing data is transmitted from the encoding center to the mail processing plant, and the mail processing devices process the mailpieces using the mail processing data from the encoding center.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified overview of the initial components or steps in systems consistent with the present invention;

FIG. 2A is a first view of an exemplary mailpiece, consistent with the present invention;

FIG. 2B is a second view of an exemplary mailpiece, consistent with the present invention;

FIG. 3 illustrates an exemplary identification tag, consistent with the present invention;

FIG. 4 is a simplified overview of a mailpiece as it enters a Universal Coding System, consistent with the present invention;

FIG. 5 illustrates an exemplary Universal Coding System, consistent with the present invention;

FIG. 6 is a simplified overview of a Universal Coding System, consistent with the present invention;

FIG. 7 is a flowchart showing a method for processing images in a Universal Coding System using First In First Out processing, consistent with the present invention;

FIG. 8 illustrates an exemplary Universal Coding System using First In First Out processing, consistent with the present invention;

FIG. 9 illustrates an exemplary Universal Coding System returning result data, consistent with the present invention;

FIG. 10 is a flowchart showing a method for processing images in a Universal Coding System using product type processing, consistent with the present invention;

FIG. 11 illustrates an exemplary Universal Coding System utilizing product type processing, consistent with the present invention;

FIG. 12 is a simplified overview of a Universal Coding System using load balancing, consistent with the present invention;

FIG. 13 is a flowchart showing a method for processing images in a Universal Coding System using load balancing, consistent with the present invention;

FIG. 14 is a first illustration of an exemplary Universal Coding System using load balancing, consistent with the present invention; and

FIG. 15 is a second illustration of an exemplary Universal Coding System using load balancing, consistent with the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts. Although embodiments consistent with the invention are described with reference to a mail system, the invention is not so limited. Rather, the invention may also be employed in other types of delivery systems.

I. Overview of Universal Coding System

To provide improved performance in the RBCS, the United States Postal Service developed the Identification Code Sorting (ICS) system, which is described in U.S. Pat. No. 6,894,243, and the Universal Coding System (UCS). These systems identify and process mail and other items such as forms using a redundant identification code within a global identifying and processing system. Embodiments of the present invention may be practiced with systems such as the RBCS, ICS systems, and UCS.

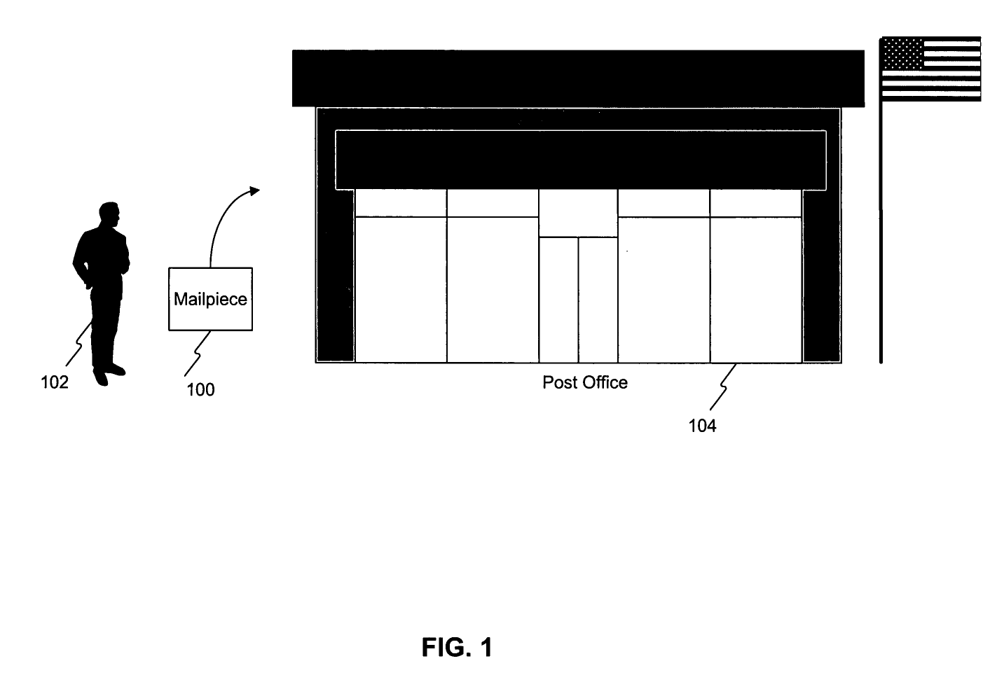

FIG. 1 is a simplified overview of the initial components or steps in systems consistent with the present invention. In FIG. 1, a delivery item, such as a mailpiece 100, is carried by a postal customer 102 to a Post Office 104. Mailpiece 100 can be, for example, a letter, flat, bundle, or parcel that postal customer 102 wishes to send to a destination address. To do so, postal customer 102 marks mailpiece 100 with a destination address and delivers it to Post Office 104. Mailpiece 100 may also be a business-related form such as a Change of Address (COA) form or Electronic Customs manifesting (ECM) form. Post Office 104 can be a United States Postal Service (USPS) POST OFFICE™, a USPS mailbox, or any other facility or location capable of receiving a mailpiece or other item for delivery to a destination address using a system for identifying and processing mail such as the RBCS, ICS system, or UCS.

A. POSTNET Code

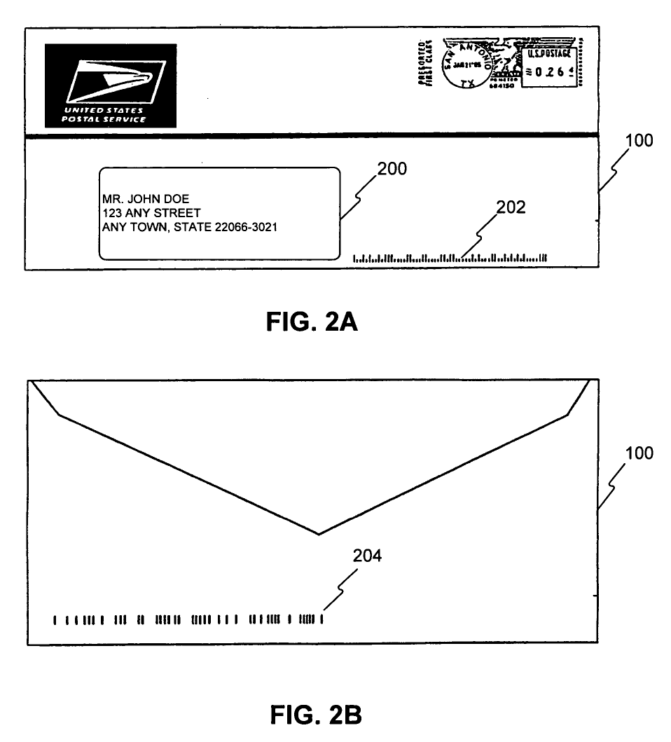

FIGS. 2A and 2B illustrate an example of a mailpiece 100, consistent with the present invention. As shown in FIG. 2A, mailpiece 100 contains two sources of delivery information, a destination address 200 and a POSTNET code 202 corresponding to destination address 200. For example, POSTNET code 202 can correspond to a Zone Improvement Plan (ZIP™) Code portion of destination address 200. POSTNET code 202 can be placed on mailpiece 100 by postal customer 102 or by the USPS at a processing center, e.g., Post Office 104. In systems consistent with the present invention, POSTNET code 202 can be read and used to route mailpiece 100 to a delivery facility, such as a Post Office, corresponding to destination address 200. Therefore, if destination address 200 is illegible, POSTNET code 202 provides an alternative source of delivery information.

B. Identification Taq (ID Tag)

As shown in FIG. 2B, mailpiece 100 includes an identification code 204, also known as an identification tag (ID Tag), which is unique to mailpiece 100. ID Tag 204 provides access to a database for an alternative source of delivery information in one embodiment of systems using apparatus or methods for identifying and processing mail consistent with the present invention. ID Tag 204 is printed on the back of mailpiece 100 and represents a unique identification source for identifying mailpiece 100. ID Tag 204 may be printed on mailpiece 100 in fluorescent ink. In certain embodiments of systems consistent with the present invention, ID Tag 204 is used as a redundant source of identification throughout all phases of address recognition and processing system such as RBCS, ICS system, or UCS.

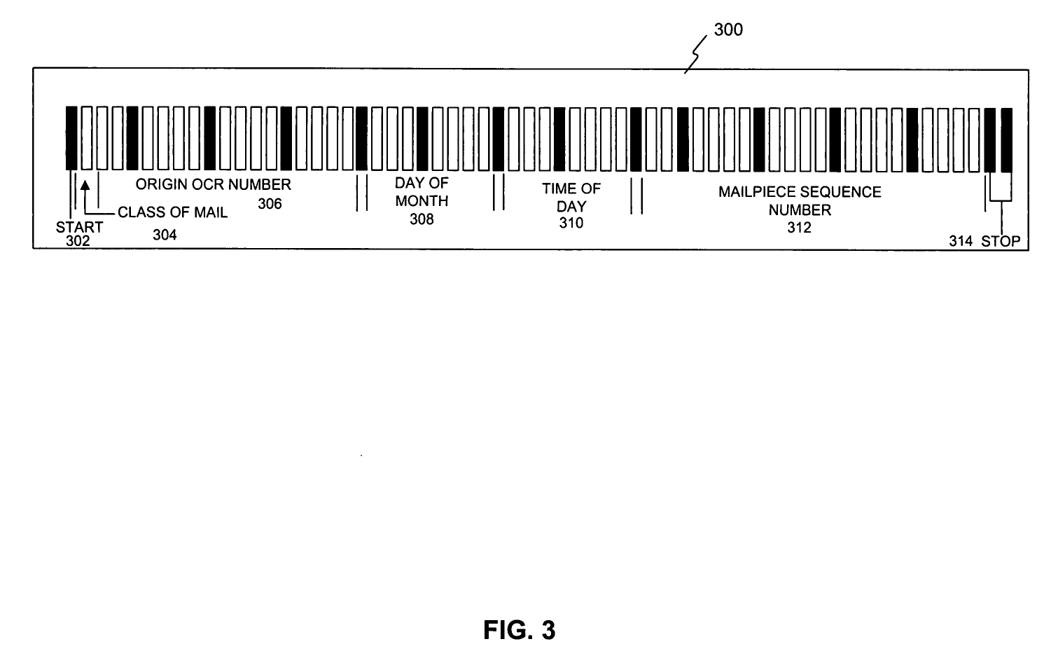

FIG. 3 shows an example of an ID Tag 204 in greater detail. In this example, ID Tag 204 is represented by ID Tag bar code 300. ID Tag bar code 300 can contain bars and spaces indicating various information about mailpiece 100, including class of mail 304, origin optical character reader (OCR) number 306, day of the month code 308, time of day code 310, and mailpiece sequence number 312. Class of mail code 304 can be represented by a single bit, representing either a 0 or a 1 to indicate mail classification. Origin OCR number 306 can be a series of 14 bits representing a machine ID number between 1 and 3,999. Day of the month code 308 can be a series of 7 bits representing a day of the month between 1 and 31. Time of day code 310 can be a series of 7 bits representing a time of day, measured in half hour increments, between 0 and 47. Mailpiece sequence number 312 can be a series of 18 bits representing a mailpiece sequence order from 1 to 25,000. In addition, ID Tag bar code 300 representing ID Tag 204 also contains a start code (such as a start bit) and a stop code (such as a stop bit). In ID Tag bar code 300, start code 302 is represented by a single bit and stop code 314 is represented by two bits. In one embodiment of systems consistent with the present invention, the combination of information represented in ID Tag bar code 300 uniquely identifies mailpiece 100. However, ID Tag 204 may be represented by formats other than ID Tag bar code 300.

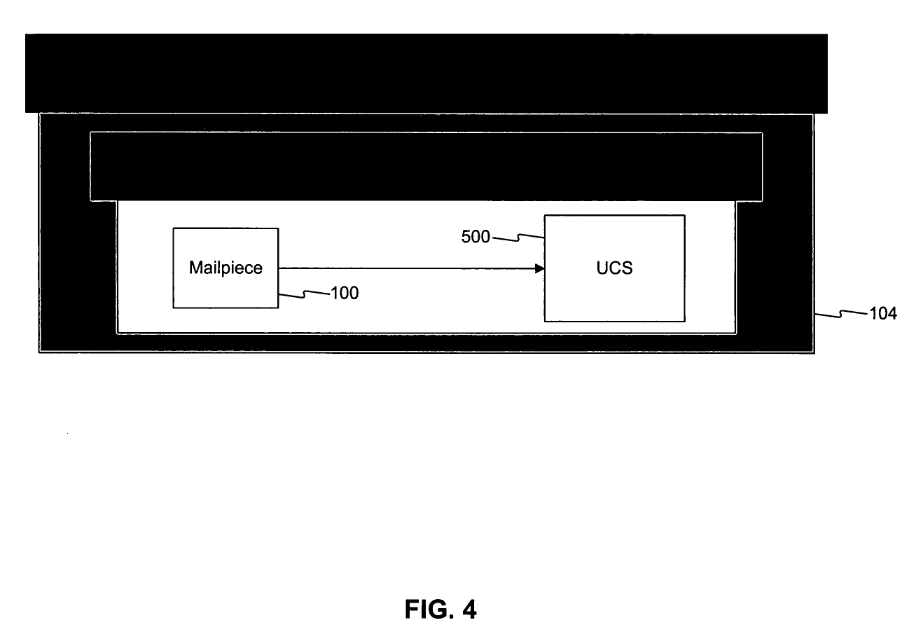

FIG. 4 depicts a simplified overview of a mailpiece as it enters a Universal Coding System (UCS) 500 in a Post Office 104. As shown in FIG. 4, mailpiece 100 enters UCS 500 for identification and processing to a destination address. In UCS 500, mailpiece 100 can be identified by POSTNET code 202, which represents the ZIP™ Code of the destination address, and/or ID Tag 204, which is stored within UCS 500 as an identification code. UCS 500 may actually apply both POSTNET code 202 and ID Tag 204 to mailpiece 100. For example, UCS 500 may first mark mailpiece 100 with ID Tag 204, and then mark mailpiece 100 with POSTNET code 202. Then, after mailpiece 100 has been marked with POSTNET code 202, it may be sorted in UCS 500 based on POSTNET code 202, provided POSTNET code 202 is legible. Sorting based on POSTNET code 202 may include determining a delivery point code. A delivery point code may be any graphical or numerical code that incorporates address data. In one embodiment, a delivery code includes at least 5 digits of a ZIP™ Code.

If POSTNET code 202 is not legible, UCS 500 may use a special machine or method to identify and process mailpiece 100 to a destination address based on ID Tag 204. If ID Tag 204 is legible, UCS 500 can obtain POSTNET code 202 from a database and thereby identify and continue to process mailpiece 100 to the destination address. If this occurs, UCS 500 may reapply POSTNET code 202 to mailpiece 100 and again attempt to identify and process mailpiece 100 to the destination address 200.

II. Detailed Description of Universal Coding System

Mail processing devices and systems process a variety of mailpieces, also referred to as delivery items, and other items, such as letters, flats, packages, bundles, scanned forms, etc. Part of this processing often involves automated reading by, for example, a bar code reader or optical character reader, etc. When a mailpiece cannot be processed in this way, an image of the mailpiece is used to complete processing. In the Universal Coding System (UCS), the image may be presented to an operator at an image encoding center, such as a Remote Encoding Center (REC), for data entry. The REC, also referred to as a REC UCS, may be at a location remote from the processing facility where the actual mailpiece is being processed. Once the address of the image is resolved, i.e., once the operator obtains the needed information from the mailpiece image, the delivery information is returned to the processing facility and the mailpiece is further processed. Often, the delivery information, also referred to as mail processing data or item processing data, needs to be returned within a matter of minutes or seconds to keep pace with the mail processing equipment handling the physical mailpiece.

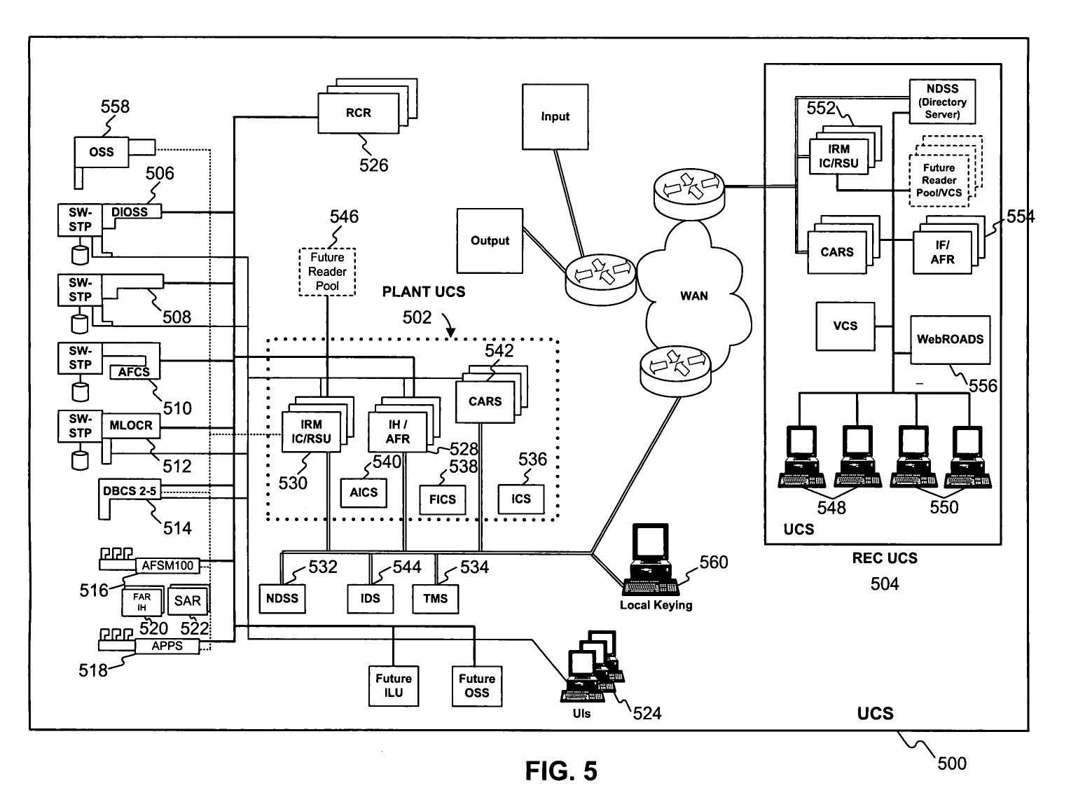

FIG. 5 shows an exemplary Universal Coding System (UCS), also referred to as a coding system, 500 consistent with the present invention. UCS 500 may include systems and devices located in one or more mail processing plants (e.g., Plant UCS 502) and in one or more Remote Encoding Centers, also referred to as Encoding Centers (e.g., REC UCS 504). In one embodiment, UCS 500 may include up to 15 REC UCS sites. The Plant UCS 502 is connected to a variety of image lift units (ILU) within a variety of Input Subsystems 506-522 such as optical character readers, bar code scanners, and mail sorting devices. The Plant UCS 502 collects images, such as mailpiece images, from these ILUs. In one embodiment, an image is only taken if the mailpiece, or delivery item, cannot be immediately mechanically sorted. A Plant UCS may be connected to, for example, up to 150 ILUs, up to 100 flat or parcel ILUs, and up to 200 Output Subsystems (OSS). These input subsystems may include, for example, Delivery Bar Code Sorter with Optical Character Reader, Input Subsystem and Output Subsystem (DIOSS) 506, Combined Input/Output Subsystem (CIOSS) 508, Advanced Facer Canceller System (AFCS) 510, Multi-line Optical Character Reader (MLOCR) 512, Delivery Bar Code Sorter (DBCS) 514, Automated Flats Sorting Machine 100 (AFSM 100) 516, Automated Package Processing System (APPS) 518, Flat Address Reader (FAR) 520, Secondary Address Reader (SAR) 522, etc. Input Subsystems 506-522 capture images of mailpieces and send these images to Plant UCS 502 accompanied by associated image attributes such as mailpiece image product attributes, mailpiece identifiers (ID tags), processing parameters, and Image Set(s). In this manner, images of mailpieces processed by a first mail processing device and/or a second mail processing device are captured. The coding system stores the images sent by Input Subsystems 506-522 at the mail processing plant and may also store the associated image attributes with the images.

Prior to processing these images, the Plant UCS 502 may create a specific coding strategy to determine which coding steps should be performed for an image based on the image attributes. The coding strategy drives the depth of code, for example, a certain number of digits of a delivery point code, that is required to sort some mailpieces, and in some instances, the Plant UCS 502 may send the coding strategy or sort plan to the REC UCS 504. To process the images, the Plant UCS may communicate with Output Subsystems (OSS) 558 to determine information required for Output Subsystem (OSS) processing. In addition, after processing, the OSS may apply a POSTNET code corresponding to the result data provided by the REC UCS to the mailpiece.

The Plant UCS may also be connected to: User Interfaces (UI) 524 to provide access to system functionality and statistical displays; Remote Computer Readers (RCR) 526 for optical character recognition; an interface to the National Directory Support System (NDSS) 532 for directory downloads; a Tray Management System (TMS) 534 to synchronize timing of processing; additional offline optical character reader systems, such as a Future Reader Pool 546; and a Local Keying function 560 for manual entry of delivery address data to obtain delivery information. The Plant UCS may also interface with an Integrated Data System (IDS) 544 which collects data from mail processing equipment.

The Plant UCS may include: Image Handlers (IH/AFR) 528 to control the handling/processing of the image files; Image and Result Managers (IRM) 530 to handle results of the encoding and OCR processes. The Plant UCS 502 may also include interfaces with other sorting systems, including Identification Code Sorting (ICS) 536, Flats Identification Code Sorting (FICS) 538, APPS Identification Code Sorting (AICS) 540, and Change of Address Record Server (CARS) 542. For example, the UCS 500 may process and identify mailpieces and other items for these other sorting systems. One having skill in the art will appreciate that UCS 500 may be capable of interfacing with additional form and data servers and systems. For example, the UCS 500 may send incomplete forms to a REC for keying additional data elements and forward the resulting information to a non UCS database. In one embodiment, Plant UCS 502 may also be able to communicate with one or more other Plant UCS.

The Plant UCS 502 may communicate with, and transmit images to, the REC UCS 504 via T1, MNS+, vBNS or other Wide Area Network, such as the Internet. At the REC UCS 504, mailpiece images may be received from one or more Plant UCS such as Plant UCS 502 and are processed by operators who view the mailpiece images and enter information about the corresponding mailpiece into a computer. The images are thus processed at the encoding center at the remote location in the sorted order to obtain mail processing data from the images.

The REC UCS 504 may also receive test harness images, which are images tagged by ILUs at mail processing equipment and which set the value within the image header providing details of the required encoding devices. REC UCS 504 will receive tagged test harness images only if the value set within the header requires the image to be keyed by the REC UCS. The test harness images will be sent to a REC UCS even if the image is finalized by another device, such as a MPE or a RCR.

The REC UCS 504 may include Supervisor User Interface computers 548 and Universal Coding Desks 550, also referred to as universal video display terminals. In one embodiment, REC UCS can process mailpiece images from all types of mail processing equipment. REC UCS Image and Result Manager IRM 552 controls the results handling of the encoding or OCR process and the REC UCS Image Handler (IH/AFR) 554 controls the handling/processing of image files. The REC UCS 504 may communicate with Web Remote Encoding Center Operations Analysis Database System (WebROADS) 556 to provide analysis of REC UCS processing. REC UCS 504 may also include a Video Coding System (VCS) for controlling image flow, a reader pool for character recognition, a connection to a Change of Address Record Server (CARS), and a connection to the National Directory Support System (NDSS).

In UCS 500, unresolved images (e.g., mailpiece images or form images) are captured from mail processing equipment, also referred to as mail processing devices, within a plant. The images are sent to Plant UCS, such as Plant UCS 502, where the images are stored and then sent to one or more Remote Encoding Centers (REC UCS) such as REC UCS 504 for processing. In an embodiment, unresolved images, partially resolved images, and finalized results are received by the Plant UCS. The images may also be sent to a reader pool within Plant UCS 502 or to the Local Keying function 560 before they are sent to REC UCS 504. Within REC UCS 504, the REC operators, or keyers, may be presented with images based on prioritization of the recognition system, as well as the total number of images of the mailpiece. REC operators at Universal Coding Desks 550 view the unresolved images and input mailpiece address data into the Universal Coding Desks 550. The mailpiece address data may be, for example, a full or partial ZIP™ Code, name, street address, city, or state, or some combination of these, and may be input by keying or by voice encoding. Universal Coding Desks 550 may have the capability to process images captured by multiple types of Input Subsystems 506-522, and in one embodiment, Universal Coding Desks 550 have the ability to process images captured by all types of Input Subsystems 506-522 and including letters, flats, parcels, address block, Region Of Interest (ROI), Postal Automated Redirection System (PARS), and ECM and COA forms. A Universal Coding Desk display may include the site name, machine type, machine number that lifted the image, and if applicable, induction/feeder number and/or camera number.

After a REC operator has input address data, the REC UCS 504 further processes the images by querying information databases, such as address information databases, using the address data to resolve the image. Resolving the image may involve providing a POSTNET code, providing a ZIP™ Code, or providing a delivery point code which has been processed to achieve the most information about the address (the finest depth of code) that can be obtained from the database for that address. The REC UCS 504 may then store the result information, also referred to as mail processing data or sorting data, and then returns the needed information to the Plant UCS 502, the Output Subsystem 558, or to the Input Subsystems 506-522. The mail processing data may be a graphical code, a delivery point code, a ZIP™ Code, or a POSTNET code. If REC UCS 504 provides the sorting information to the Plant UCS 502, Plant UCS may then send the sorting information to the Output Subsystem 558, the Input Subsystems 506-522, or to an identification code server for local access by a sorter if the identification code server is not integrated into UCS. In one embodiment, Plant UCS 502 sends sorting information, also referred to as mail or item processing data, to the Output Subsystem 558 or the Input Subsystems 506-522 in response to a request or query for the mail processing data sent by the mail processing device, such as the Output Subsystem 558 or the Input Subsystems 506-522.

The UCS may also support remote OSS capability, or the ability to provide output data such as the delivery point code to a different plant than the plant from which the image was sent and ultimately to a different mail processing device than that which captured the image. In this manner, the mailpiece can be transported to a final destination or an intermediate processing hub based on available address data while the delivery point code is determined to the finest depth of code possible by the REC.

In one embodiment, Plant UCS 502 and REC UCS 504 may have overload protection mechanisms to control or stop image transfer should the image storage capacity be reached at either. The UCS may also have image result management capabilities, such as, for example, the ability for a user to add, update, delete, view and print processing result entries.

Different pieces of mail processing equipment at a single Plant UCS may send images to different RECs for resolution. In addition, any image or type of image may be sent to many REC sites. Further, images from many different mail processing locations may be sent to the same REC for processing.

Problems can arise when different quantities of images come from different plants. For example, a single REC might handle thousands of images from a New York City plant and only a few hundred from a plant in Reading, Pa. The smaller plant may end up waiting long periods of time for its images to be processed because the REC operators are overwhelmed with images from the larger plant. Other problems can arise when images represent different product types (e.g., letters or flats) because the mail processing machines handling the mailpieces, such as the Input Subsystems 506-522, may need very different response times from the REC operators. For example, some types of mail (e.g., flats, parcels) need to be resolved within 90 seconds (on-line processing) while others (e.g., letters, forms, international mail) can wait longer (off-line processing).

Thus, it is desirable to develop methods for controlling the processing of mailpiece images at Remote Encoding Centers (REC) and mail processing and distribution facilities. In particular, load balancing methods may utilize configuration data with REC, Mail Processing Equipment (MPE), and Time Value information for controlling the processing order of mailpiece images.

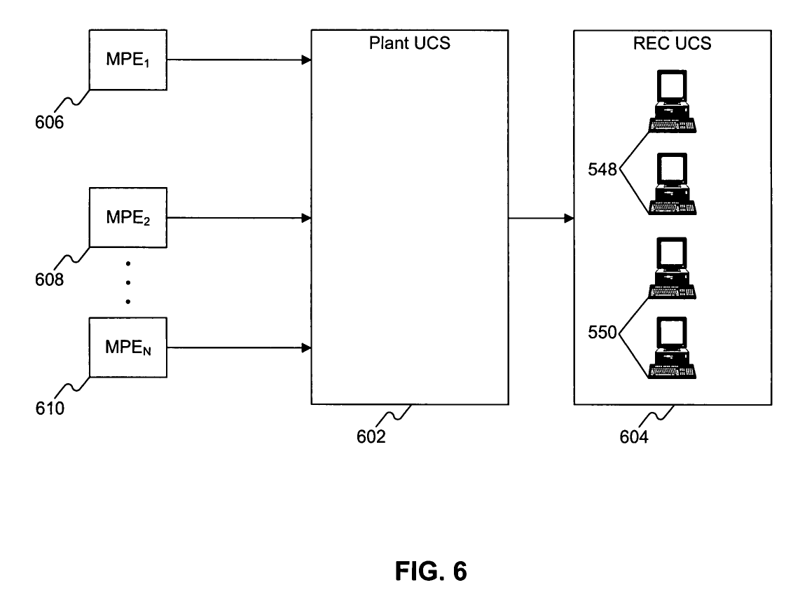

FIG. 6 shows a simplified overview of a Universal Coding System (UCS) 500. In FIG. 6, Plant UCS 602, communicates with First Mail Processing Equipment, also referred to as First Mail Processing Device, (MPE₁) 606 and Second Mail Processing Equipment, also referred to as Second Mail Processing Device, (MPE₂) 608. Plant UCS 602 may also communicate with Additional Mail Processing Equipment (MPE_{N}) 610. Mail Processing Equipment 606, 608, and 610 may also be referred to as item processing devices or item processing equipment and may be, for example, Input Subsystems 506-522. Plant UCS 602 communicates with Remote Encoding Center (REC) UCS 604 over a Wide Area Network, such as the Internet. REC UCS 604 includes Supervisor User Interface computers 548 and Universal Coding Desks 550.

III. FIFO Load Balancing

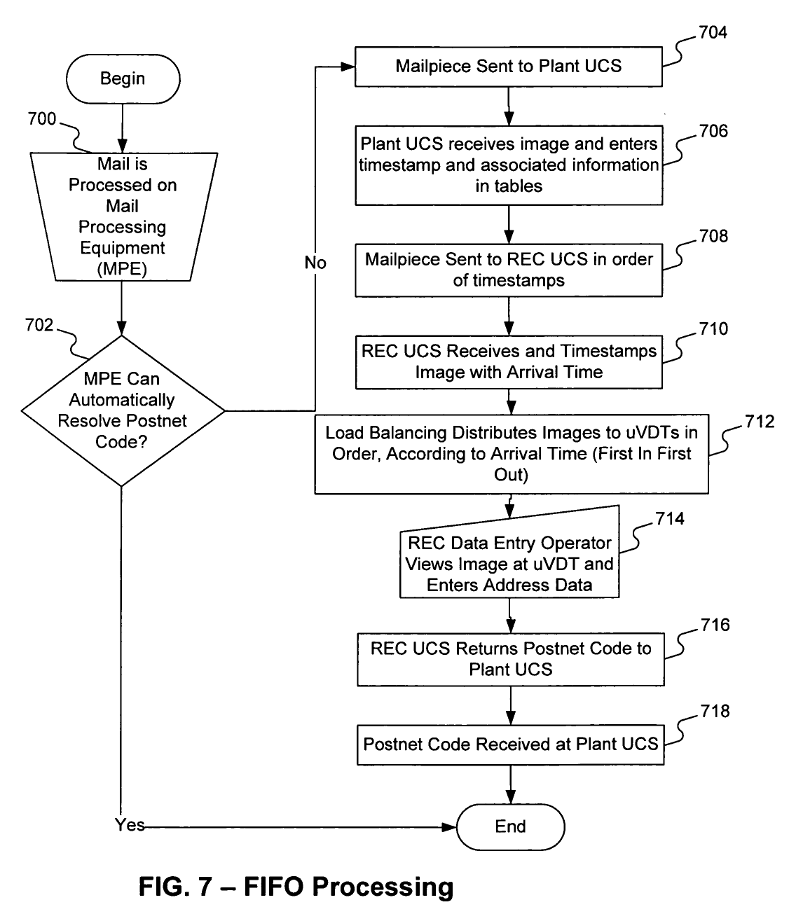

One method of load balancing at a REC uses First In First Out (FIFO) processing. In one embodiment, FIFO processing utilizes data containing time values, or time characteristics, to control the order of mailpiece image processing at mail processing facilities and RECs. These time characteristics may include, for example, image capture times and image receipt times. FIG. 7 is a flowchart showing a method for processing images in a Universal Coding System using First In First Out processing, consistent with the present invention.

Load balancing based on FIFO Processing Management may utilize time characteristics such as time values entered into a table to determine the processing order of a particular mailpiece image. As mail is processed on First Mail Processing Equipment 606 at a plant UCS (Step 700), an Identification Tag (ID Tag) is applied to each mailpiece, an image of each mailpiece is captured, and header information along with the ID Tag is associated with the image. If the mailpiece address cannot be resolved by the MPE (Step 702), the MPE forwards the image to the plant UCS (Step 704). As the image enters the plant UCS, the plant UCS records the entry time and header information in a table for use with FIFO Processing Management in determining the order of image processing based on a First In First Out algorithm (Step 706).

The plant UCS sorts the images at the coding system according to time characteristics such as an image capture time or an image receipt time. Once the plant UCS determines the next image to be processed, the image is forwarded to a REC, such as REC UCS 604, for encoding (Step 708). Using First In First Out processing, this determination is based on the capture time of the image. Alternately, this determination may be based on the time of receipt of the image at the Plant UCS so that the first image received by the UCS is the first image sent to the REC for encoding. In this manner, the images are transmitted from the mail processing plant to a remote location. At the remote location, the images are processed at an encoding center, also referred to as REC UCS, in the sorted order to obtain mail processing data from the images. As the image enters the REC UCS, the entry time is recorded (Step 710). The entry time, as recorded in the REC UCS table, is used to determine the order in which the mailpiece image is presented to an encoding device, such as Universal Coding Desks 550, for processing (Step 712). At the encoding device, a REC operator views the mailpiece image and enters address data about the mailpiece (Step 714). The UCS REC provides mail processing data such as a POSTNET code using the data entered by the REC operator. In this manner, the images are processed at an encoding center at the remote location in the sorted order to obtain mail processing data from the images.

The results of the encoding processes are then forwarded back, or transmitted, from the encoding center to the plant UCS such as Plant UCS 602 (Step 716). The plant UCS receives the mail processing data (Step 718) and sends the data or makes it available to the MPE. The mail processing device then uses the mail processing data, such as the POSTNET code, to process, or sort, the mail. In one embodiment, the plant UCS keeps a count of images it sends to an encoding center and thus knows when it has received all the result data, or mail processing information, from each REC UCS. In this manner, the plant UCS can make the result data, or mail processing information, available to the mail processing equipment as soon as it receives the last image from the REC UCS.

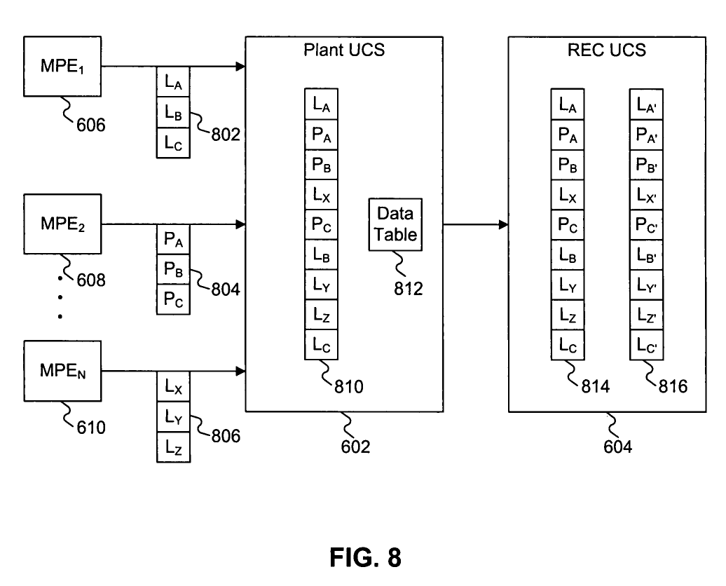

FIG. 8 shows an exemplary Universal Coding System (UCS) 500 utilizing FIFO processing. Specifically, mail is processed on First Mail Processing Equipment 606 at a plant UCS, and an Identification Tag (ID Tag) is applied to each mailpiece. An image of a mailpiece, or, in one embodiment, a rejected mailpiece, is captured, and header information along with the ID Tag is associated with the image. In this exemplary embodiment, the mailpiece addresses for three letters, letter A, letter B, and letter C, cannot be resolved by First Mail Processing Equipment 606. First Mail Processing Equipment 606 sends image data 802 to Plant UCS 602 including an image of letter A (L_{A}) that is sent when it is captured, an image of letter B (L_{B}) that is sent when it is captured, and an image of letter C (L_{C}) that is sent when it is captured. The mailpiece addresses for three parcels, parcel A, parcel B, and parcel C, cannot be resolved by Second Mail Processing Equipment 608, and Second Mail Processing Equipment 608 forwards image data 804 including an image of parcel A (P_{A}), an image of parcel B (P_{B}), and an image of parcel C (P_{C}) to Plant UCS 602 as each image is captured. Similarly, the Additional Processing Equipment 610 cannot resolve mailpiece addresses for three letters, letter X, letter Y, and letter Z, and forwards image data 806 including an image of Letter X (L_{X}), an image of Letter Y (L_{Y}), and an image of Letter Z (L_{Z}) to Plant UCS 602. Again, each individual image L_{X}, L_{Y} and L_{Z} is sent to Plant UCS 602 when it is captured.

Thus, a first image of a first delivery item to be processed at a first mail processing device, the image of letter A (L_{A}) is captured, and a second image of a second delivery item to be processed at a second mail processing device (L_{B}) is captured and sent to a coding system. In this manner, mailpieces processed by the First Mail Processing Equipment 606 and the Second Mail Processing Equipment 608 may be of different types (ex. letters and parcels), and First Mail Processing Equipment 606 and Second Mail Processing Equipment 608 may be different types of mail processing equipment.

The coding system, and specifically the Plant UCS 602, receives the images in image data 802, 804, and 806 from Mail Processing Equipment 606, 608, and 610. Plant UCS 602 may then accumulate the images in image data 802, 804, and 806 in combined images 810, which Plant UCS may place in a data table 812 based upon the order the images were received by the Plant UCS 602. For example, combined images 810, and data table 812, include the image of letter A (L_{A}), then the image of parcel A (P_{A}), then the image of parcel B (P_{B}) because this is the order the Plant UCS 602 received these images. Plant UCS 602 may also store additional data along with the image, such as an ID Tag, the source of the image, the image product type, and the age of the image.

The Plant UCS 602 then determines the next image to be sent to the REC UCS 604 by sorting the images according to time characteristics of the images. The time characteristics may include the timestamp of the image or data table 812 so that the first image received by the UCS is the first image sent to the REC for encoding. One of skill in the art will note that the time characteristics could include the capture time of the image at the Mail Processing Equipment 606, 608, and 610, image receipt times at the Plant UCS 602, or both. Alternately, Plant UCS 602 could order at least a portion of or all of the images to be in Last In First Out (LIFO) order before sending the images to the REC UCS 604.

The Plant UCS then sends the images to the REC UCS 604 for encoding according to the sending order to obtain mail processing data. The images are received at the REC UCS 604, and the entry time, as recorded in the REC UCS table, is the time the REC UCS 604 receives an individual image such as image L_{A}. The entry time is used to determine the order 814 in which the mailpiece image is presented to an encoding device, such as Universal Coding Desks 550, for processing. In addition, the REC UCS 604 may distribute the images to encoding devices and operators at the encoding center based on priority data.

The images are processed at the image encoding center to obtain mail processing data such as a POSTNET code. Specifically, at Universal Coding Desks 550, a REC operator views an image, such as image L_{A}, and enters address data about letter A based on the image such as a partial address or a ZIP™ Code. After a REC operator inputs address data, the REC UCS 604 further processes the images by querying information databases using the address data to resolve the image. In this manner, the images are processed at the encoding center, or REC UCS 604, in the sorted order to obtain mail processing data from the images. Thus, a first image such as image L_{A} is processed to obtain first mail or item processing data, and a second image such as image P_{A} is processed to obtain second mail or item processing data. Resolving the image may involve providing a POSTNET code, providing a ZIP™ Code, or providing a delivery point code. REC UCS 604 may create result data 816. In one embodiment, the Universal Coding Desks 550 have different modes allowing REC Operators to enter different information. For example, the Universal Coding Desks 550 may allow REC Operators to enter only numeric information, address information, or name information, or some combination of this information. REC UCS 604 may receive images from up to 450 plant sites and may include up to 4500 Universal Coding Desks.

One having skill in the art will note that the UCS may use an authorized commercial names database as part of the processing used in determining the final resolution of an address. This database may be stored at a REC UCS, plant UCS or any other authorized location accessible via Wide Area Network.

In one embodiment, the UCS periodically notifies the REC UCS of the status of operation of each mail processing equipment. This may include, for example, the minimum depth of sort required, the mode of operation, and the machine number.

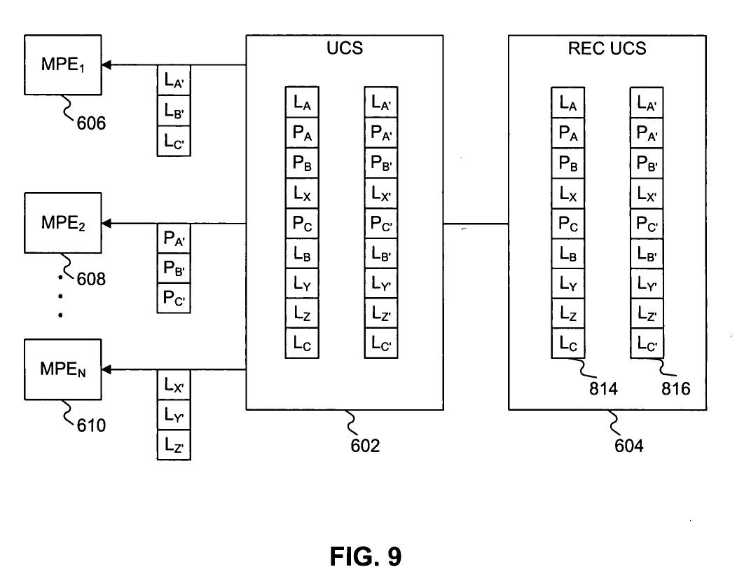

FIG. 9 illustrates an exemplary Universal Coding System returning result data, consistent with the present invention. The results of the encoding processes, the result data 816, such as first and second mail processing data, are then forwarded back, or transmitted, to the coding system, and specifically to the originating plant UCS or directly to the Mail Processing Equipment. The Plant UCS 602 receives the result data and sends it to First Mail Processing Equipment 606, Second Mail Processing Equipment 608, and Additional Mail Processing Equipment 610. Specifically, first mail processing data may be sent to the First Mail Processing Equipment 606 and second mail processing data may be sent to Second Mail Processing Equipment 608. The mailpieces are then processed, or sorted, by the Mail Processing Equipment, or Mail Processing Devices, using the mail processing data from the encoding centers. For example, letter A is processed, or sorted, by the First Mail Processing Equipment 606 using first mail processing data, and parcel A is processed, or sorted, by the Second Mail Processing Equipment 608 using second mail processing data. In one embodiment, Plant UCS 602 sends the result data to the First Mail Processing Equipment 606, Second Mail Processing Equipment 608, and Additional Mail Processing Equipment 610 upon receipt of a query for the data sent by the Mail Processing Equipment 606, 608, and 610. After an image is processed, UCS 500 may delete the image.

IV. Product Type Processing

One method of load balancing at a REC uses Product Type processing. Load Balancing Based on Product Type utilizes data including mail processing equipment (MPE) type, mail product type, and expected turnaround time for each product type at the plant to determine the order and priority of image processing. This data determines which MPE or mail product type can be sent to which REC and the expected turnaround time for each product type. The MPE type could indicate, for example, whether the mailpiece corresponding to an image is being processed on letter processing equipment or flats processing equipment. The mail product type may indicate the type of item that corresponds to the image, such as letter, flat, parcel, bar-coded, and form, etc. The expected turnaround time could represent the image processing time needed by a certain MPE, by a plant, or by a product type, and may begin when an image arrives at a REC and end when the result is received at the plant. Each plant UCS may maintain an individual plant turnaround table and may sent this to each of the RECs which processes images from that plant UCS. Each plant may alternately have multiple turnaround tables, such as one for each day of the week. In one embodiment, plant personnel manually configure these values, providing a great deal of flexibility and configurability in the system.

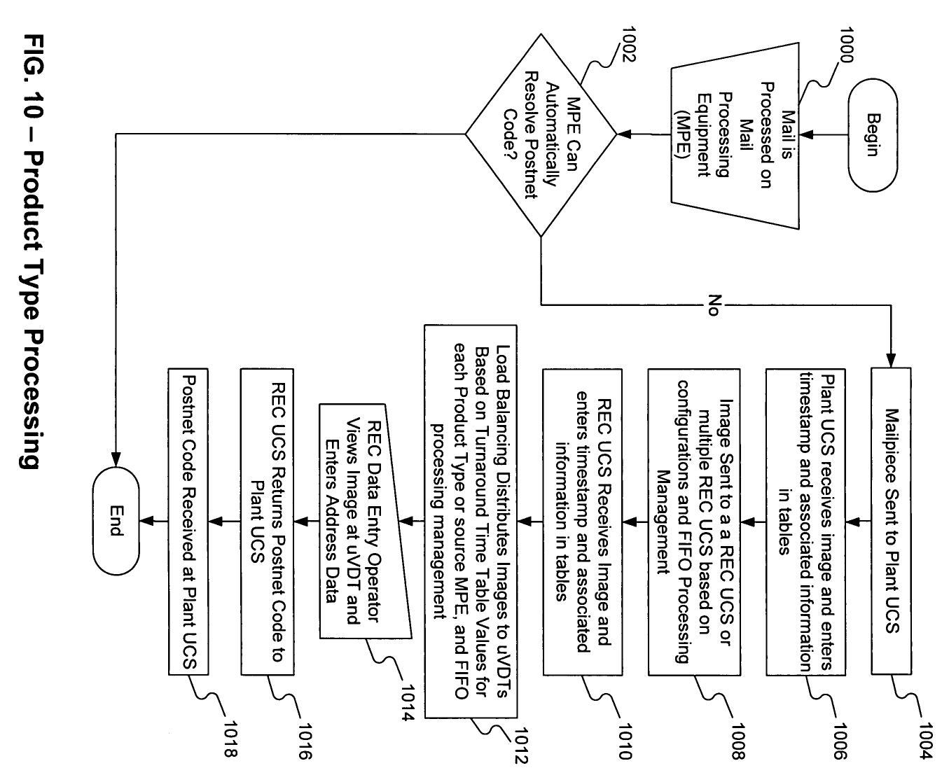

FIG. 10 is a flowchart showing a method for processing images in a Universal Coding System based on Product Type, consistent with the present invention. As mail is processed on mail processing equipment (MPE) such as First Mail Processing Equipment 606 (Step 1000), an ID Tag is applied to each mailpiece, an image of each mailpiece is captured, and header information is associated with the image and ID Tag. For example, a first image of a mailpiece to be processed by a first mail processing device is captured, and a second image of a mailpiece to be processed at a second mail processing device is captured. The first mail processing device and the second mail processing device may process a first and second mail product type, respectively. If the mailpiece address cannot be resolved by the MPE (Step 1002), the mailpiece image and related information is sent to a coding system, and specifically to a plant UCS such as Plant UCS 602 (Step 1004), where the images (such as first and second images) and time information are received and stored together with the image header information (Step 1006). The images are then sorted at the coding system according to characteristics of the images, such as product type. The image characteristics may include at least one of mail processing device or apparatus data such as the specific mail processing device where the image was captured, delivery item data, product or mailpiece type data, expected turnaround time data, and priority data. The sorting of the images may also involve using First In First Out processing.

Images may then be sent, or transmitted, to a remote location and processed at an encoding center at the remote location, such as REC UCS 604, in timestamp order or according to the processing order (Step 1008). As the REC UCS receives images, another timestamp is applied and associated information is entered into REC tables (Step 1010). The REC UCS may use a Product Type Automatic Load Balancing (ALB) method to process the images, or to determine the processing order of each mailpiece image such as the first image and the second image (Step 1012). For example, the order for image processing may be based on a turnaround time value for a product type corresponding to the image. In one embodiment, images corresponding to parcels would be sent for processing first, followed by images corresponding to flats, followed by images corresponding to scanned forms, followed by images corresponding to letters.

After the processing order is determined, the images are presented to an encoding device, such as Universal Coding Desks 550, for encoding. At the encoding device, a REC operator views and enters address data from the mailpiece image (Step 1014). Thus, the first and second images are processed at an encoding center at the remote location in the sorted order, also referred to as the processing order and which may be FIFO order, to obtain mail processing data, also referred to as item processing data, from the images. Further, at least a portion of the images may be transmitted to a second remote location for processing the images at an encoding center at the second remote location. The results of the encoding processes are then transmitted from the encoding center to the coding system, and may be sent specifically to the originating plant UCS (Step 1016). When received at the plant UCS (Step 1018), the data may then be provided to a MPE or OSS. Specifically, the mail processing data may be sent to a first mail processing device and a second mail processing device, where a first mailpiece and a second mailpiece may then be processed using the mail processing data.

Load Balancing based on Product Type provides the capability to determine the destination REC based on source MPE or product type and the capability to configure and send images from a particular MPE or product type to one or many REC(s). Further, it provides the capability to configure an expected turnaround time for each MPE or product type and to integrate other load balancing methodologies such as FIFO Image Processing Management to determine the order of image processing.

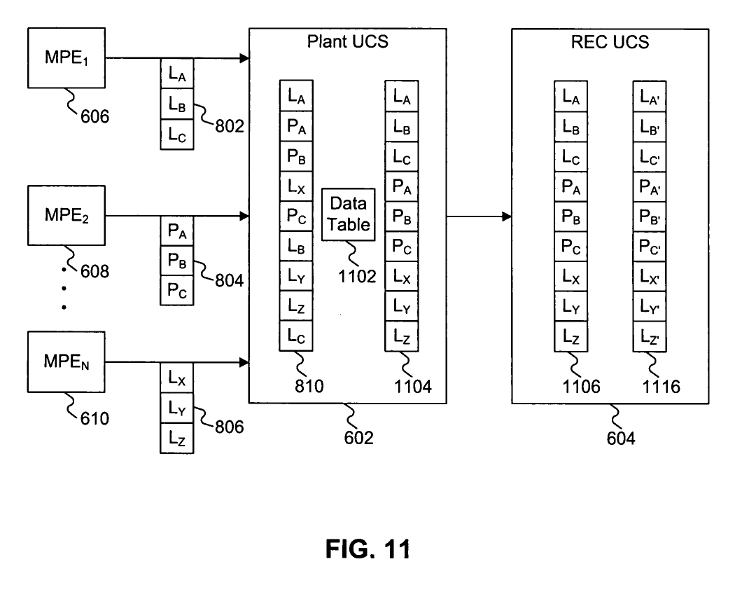

FIG. 11 shows an exemplary Universal Coding System (UCS) 500 utilizing product type processing. Specifically, mail is processed on First Mail Processing Equipment 606 at a plant UCS, an Identification Tag (ID Tag) is applied to each mailpiece, an image of each mailpiece is captured, and header information along with the ID Tag is associated with the image.

In FIG. 11, the order of the images sent by the Plant UCS 602 to the REC UCS 604 is based on time characteristics, such as the time stamp of the image in data table 1102. For example, Plant UCS 602 reorders combined images 810 to be in First In First Out (FIFO) order based on product type. Specifically, Plant UCS Order 1104 includes all of the images L_{A}, L_{B}, and L_{C} (in FIFO order) received from the First Mail Processing Equipment 606, then all of the images P_{A}, P_{B}, and P_{C} (in FIFO order) from the Second Mail Processing Equipment 608, and then all of the images L_{X}, L_{Y}, and L_{Z} (in FIFO order) received from the Additional Mail Processing Equipment 610. The Plant UCS then forwards the images to the REC UCS 604 for encoding according to the processing order.

The entry time, as recorded in the REC UCS table, is the time the REC UCS receives an individual image such as image L_{A}. The entry time is used to determine the order 1106 in which the mailpiece image is presented to an encoding device, such as Universal Coding Desks 550, for processing. At Universal Coding Desks 550, a REC operator views an image, such as image L_{A}, and enters address data about letter A based on the image, such as a partial address or ZIP™ Code. After a REC operator inputs address data, the REC UCS 604 further processes the images by querying information databases using the address data to resolve the image. Resolving the image may involve providing a POSTNET code, providing a ZIP™ Code, or providing a delivery point code. REC UCS 604 may create mail processing data, or result data, 1116. The results of the encoding processes, the result data 1116, may then be forwarded back to the originating plant UCS and ultimately to the proper mail processing equipment in a similar manner to that shown in FIG. 9. The Plant UCS may keep track of the number of images sent to the REC from a specific mail processing equipment and forward the results to the mail processing equipment upon receipt of the last image result from the REC UCS when the Plant UCS is using on-line processing.

One having skill in the art will appreciate that the Plant UCS 602 could also use different data within data table 1102 to reorder the images. For example, Plant UCS 602 could use mail product type data to reorder the images, to thereby send all of the images of a particular type (letters, parcels, flats, forms) to be processed in a FIFO manner. For example, all flats may be processed before the letters are processed. Plant UCS 602 could also use expected turnaround time data to reorder the images to accommodate mail processing equipment having particular turnaround times. Alternately, Plant UCS 602 could use priority data to reorder the images.

V. Load Balancing

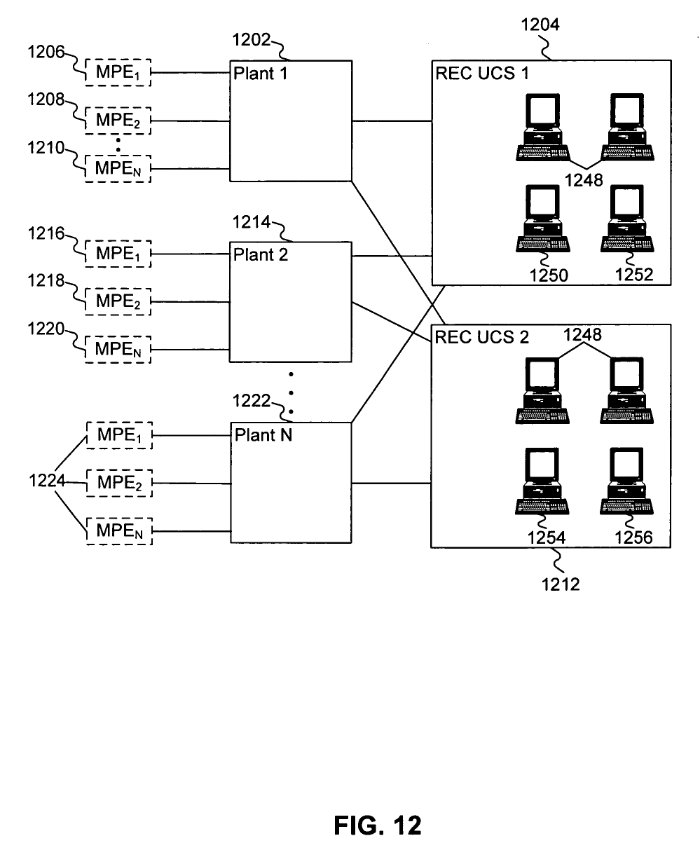

One method of load balancing at a REC uses an integrated load balancing management system. FIG. 12 shows a simplified overview of a Universal Coding System using load balancing, consistent with the present invention.

In FIG. 12, First Plant UCS 1202 communicates with First Mail Processing Equipment (MPE₁) 1206 and Second Mail Processing Equipment (MPE₂) 1208. First Plant UCS 1202 may also communicate with Additional Mail Processing Equipment (MPE_{N}) 1210. Mail Processing Equipment 1206, 1208, and 1210 may be, for example, Input Subsystems 506-522. First Plant UCS 1202 communicates with First Remote Encoding Center (REC) UCS 1204 over a Wide Area Network, such as the Internet. First REC UCS 1204 includes Supervisor User Interface computers 1248, First Universal Coding Desk 1250, and Second Universal Coding Desk 1252. First Plant UCS 1202 also communicates with Second Remote Encoding Center (REC) UCS 1212 over a Wide Area Network, such as the Internet. Second REC UCS 1212 includes Supervisor User Interface computers 1248, Third Universal Coding Desk 1254, and Fourth Universal Coding Desk 1256. First REC UCS may also communicate with Second REC UCS 1212.

FIG. 12 also shows Second Plant UCS 1214 and Third Plant UCS 1222. Second Plant UCS 1214 communicates with First Mail Processing Equipment (MPE₁) 1216, Second Mail Processing Equipment (MPE₂) 1218, and Additional Mail Processing Equipment (MPE_{N}) 1220, and Third Plant UCS 1222 communicates with Mail Processing Equipment (MPE₁) 1224. Second Plant UCS 1214 and Third Plant UCS 1222 communicate with First REC UCS 1204 and Second REC UCS 1212 over a Wide Area Network, such as the Internet.

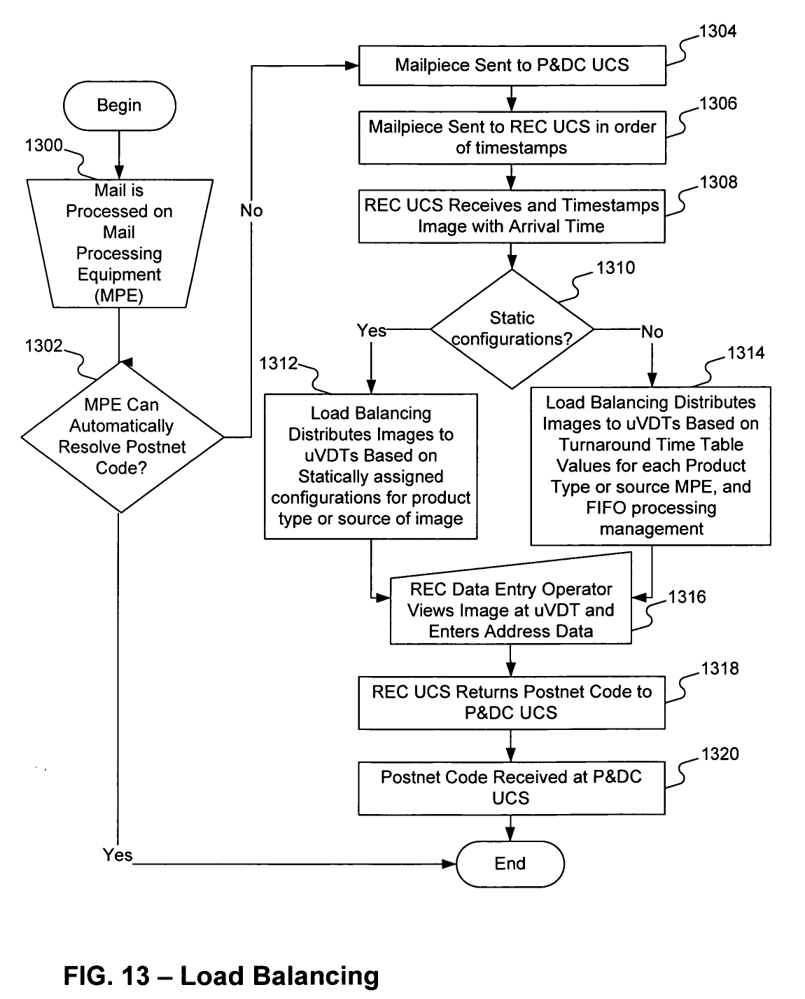

FIG. 13 is a flowchart showing a method for processing images in a Universal Coding System (UCS) using Load Balancing. REC Load Balancing may combine several different methodologies for determining how images are processed, such as FIFO Load Balancing, Load Balancing based on image source, Load Balancing based on Product Type, etc. As mail is processed on mail processing equipment (MPE) such as First Mail Processing Equipment 1206 (Step 1300), an ID Tag is applied to each mailpiece, an image of each mailpiece is taken, and header information is associated with the image and ID Tag. If the mailpiece address cannot be resolved by the MPE (Step 1302), the mailpiece image is sent to a plant UCS such as First Plant UCS 1202 (Step 1304), where the time is recorded with the image header information. The plant UCS may then prioritize the image flow from the mail processing equipment based on image characteristics, or configuration data, such as mailpiece type data, mail processing device data, turnaround time data, and priority requirements such as the number of available images, the age of the images, and the connection priority. Images are then sent to REC UCS, such as First REC UCS 1204, in timestamp order (Step 1306). When performing on-line processing, the Plant UCS may keep a count of images were sent to the REC from a specific mail processing equipment and forward the results to the mail processing equipment upon receipt of the last image result for that mail processing equipment from the REC UCS. When an image is received by the REC UCS, the entry time value and associated image information such as the ID Tag, source of an incoming image, image product type (e.g., letter, flat, PARS, Parcel, Form, etc.), and age of image are entered into REC UCS tables (Step 1308).

In certain embodiments, static configuration data may be assigned to images and processing the images may include checking for this static configuration data. Static configuration data may include, for example, priority data, image source information, such as information regarding which MPE captured the image, or product type information. For example, images corresponding to parcels or to Priority Mail items may be marked for processing before any other types of images. If static configuration data is present (Step 1310), then images are distributed accordingly to a specific encoding device or devices. For example, if First REC UCS 1204 detects that an image includes static configuration data indicating that an image corresponds to a mailpiece that is Priority Mail, the First REC UCS 1204 may select a specific encoding device, also referred to as a first encoding device, such as Universal Coding Desk 1250, to receive the images having this static configuration data (Step 1312). In this manner, images are forwarded to the Universal Coding Desks based on priority. If static configuration data is not present, the REC UCS tables along with plant product type expected turnaround time tables and available encoding resource tables are used by the REC UCS to determine the processing order of a mailpiece image. The REC UCS utilizes dynamic data, such as the information in the tables, to determine the order in which the mailpiece images will be presented for encoding and which encoding device will encode the mailpiece images. For example, a table showing current available resources may show that every encoding station at one REC UCS, such as First REC UCS 1204, is busy, so images may be sent to a different REC UCS, such as Second REC UCS 1212, that has idle encoding stations.

After the processing order and encoding devices, or encoding resources, for the images are determined, the images are distributed accordingly to the encoding devices (Step 1314). REC operators view mailpiece images and enter address data about the mailpiece based on the image (Step 1316). The results of the encoding processes are then forwarded back to the originating plant UCS (Step 1318). After the data is received at the plant UCS (Step 1320), it is sent to an MPE (for example, when performing on-line processing) or made available to the MPE upon request.

Using integrated Load Balancing, encoding resources may be dynamically allocated at the REC UCS based on dynamic data including encoding resources, such as REC operator productivity data and available coding desks data, and configuration data, such as mail processing device data, and expected turnaround data for each MPE, product type, and plant. The dynamic data may be changed at the encoding center or at the plant UCS. For example, dynamic data may include a plant product type expected turnaround table that specifies how quickly mailpiece images should be processed for a certain mailpiece type based on the MPE handling that type of mailpiece. In another example, dynamic data includes uses encoding resource data such that, for example, an administrator at First REC UCS 1204 or First Plant UCS 1202 may change information stored in the dynamic data to redirect images to one REC if another REC is experiencing technical difficulties. Encoding resources may also be allocated based on the source of the image, e.g., images for a plant that is behind in its mail sorting runs may be processed after images for other plants. In yet another example, an individual REC operator with demonstrated high productivity may be given more images to encode, or may be given images of a particular product type if the operator demonstrates productivity on a particular product. In another embodiment, an administrator may assign plants to individual REC operators (Plant Mode), in which case load balancing may not be proportioned equally with respect to plant turnaround time.

In addition, processing may involve using product pools and a priority matrix. Specifically, REC operators may be pooled into product pools based on a predefined strategy. The REC operators may then be reallocated from one product pool to another product pool based upon a priority matrix, which clarifies which REC operators can be pulled from other product pools at what times. For example, the UCS 500 will look for REC operators working on the lowest priority products for reallocation. In one embodiment, an administrator at First REC UCS 1204 or First Plant UCS 1202 may write over this priority matrix to provide additional flexibility. Further, in one embodiment, the Universal Coding Desk may smoothly transition from one product pool to another product pool without drawing this to the REC operator's attention.

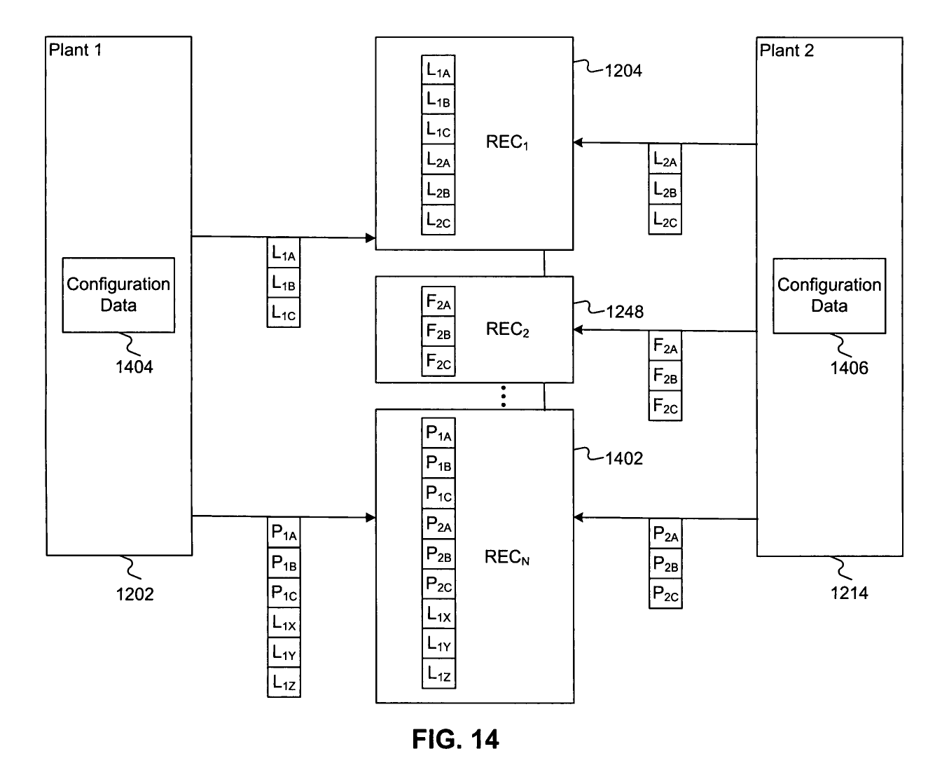

FIG. 14 shows an exemplary Universal Coding System utilizing load balancing. Specifically, mail is processed on mail processing equipment (MPE) such as First Mail Processing Equipment 1206 at First Plant UCS 1202, an ID Tag is applied to each mailpiece, an image of each mailpiece is taken, and header information is associated with the image and ID Tag. Thus, images of mailpieces processed by mail processing devices are captured. In this exemplary embodiment, First Plant UCS 1202 received an image of letter A (L_{1A}), an image of letter B (L_{1B}), and an image of letter C (L_{1C}) from First Mail Processing Equipment 1206, an image of parcel A (P_{1A}), an image of parcel B (P_{1B}), and an image of parcel C (P_{1C}) from Second Mail Processing Equipment 1208, an image of Letter X (L_{1X}), an image of Letter Y (L_{1Y}), and an image of Letter Z (L_{1Z}) from Additional Mail Processing Equipment 1210. Thus, a first image of a first delivery item to be sorted at a first mail processing device and a second image of a second delivery item to be sorted at a second mail processing device may be captured and sent to a coding system. First Plant UCS 1202 receives and stores the images and records the time of receipt of the image, as well as the image header information.

Second Plant UCS 1214 received an image of letter A (L_{2A}), an image of letter B (L_{2B}), and an image of letter C (L_{2C}) from First Mail Processing Equipment 1216, an image of flat A (F_{2A}), an image of flat B (F_{2B}), and an image of flat C (F_{2C}) from Second Mail Processing Equipment 1218, and an image of parcel A (P_{2A}), an image of parcel B (P_{2B}), and an image of parcel C (P_{2C}) from Additional Mail Processing Equipment 1220. Second Plant UCS 1214 also records the time of receipt of the image, as well as the image header information.

First Plant UCS 1202 then uses configuration data 1404 to sort the images, or determine the order and priority of image processing. Configuration data 1404 might include data pertaining to, for example, the type of MPE that captured the image, the product data such as the type of mail, priority data, or an expected turnaround type for the type of MPE that captured the image or the product type. One having skill in the art will appreciate that configuration data could further include other types of data, such as an applicable day of the week, a REC assignment based on product type, a REC assignment based on MPE, expected turnaround time, percentage of resources at REC for each plant UCS, number of operators assigned, etc. First Plant UCS 1202 may also use the time of receipt of the image at the UCS REC and the time of capture of image at the MPE to order the images in a FIFO order.

As shown in FIG. 14, First Plant UCS 1202 reorders the images to group together images received from each mail processing equipment. First Plant UCS 1202 also uses the configuration data to determine to which REC UCS it will send the images from each MPE. In an exemplary embodiment, First Plant UCS 1202 sends all of the images from a single MPE to the same REC at a remote location. Thus, using configuration data 1404, the First Plant UCS 1202 transmits, or sends, images L_{1A}, L_{1B}, and L_{1C} received from the First Mail Processing Equipment 1206 to the same REC, First UCS REC 1204. First Plant UCS 1202 sends images P_{1A}, P_{1B}, and P_{1C} received from the Second Mail Processing Equipment 1208, to an Additional REC 1402. First Plant UCS 1202 also sends images L_{1X}, L_{1Y}, and L_{1Z} received from the Additional Mail Processing Equipment 1210 to the same REC, Additional REC 1402. First Plant UCS 1202 may alternately use the configuration data 1404 to select a first remote image encoding center for a first image, and to select a second remote image encoding center for a second image.

Similarly, Second Plant UCS 1214 uses configuration data 1406 to determine to which REC UCS it will send the images from each MPE. Second Plant UCS 1214 transmits images L_{2A}, L_{2B}, and L_{2C} received from the First Mail Processing Equipment 1216 to the same REC, First UCS REC 1204. Second Plant UCS 1214 sends images F_{2A}, F_{2B}, and F_{2C} received from the Second Mail Processing Equipment 1218 to the same REC, Second REC UCS 1212. Second Plant UCS 1214 sends images P_{2A}, P_{2B}, and P_{2C} received from the Additional Mail Processing Equipment 1220 to the same REC, Additional REC UCS 1402. In this manner, a first image may be sent to and received at a first remote image encoding center, and a second image may be sent to and received at a second remote image encoding center.

When an image is received by the REC UCS, the entry time value and associated image information such as the ID Tag, source of an incoming image, image product type (e.g., letter, flat, PARS, Parcel, Form, etc.), and age of image is entered into REC UCS tables. The images are then load balanced at the First REC UCS 1204 using dynamic data.

One having skill in the art will appreciate that each Plant UCS could select the REC to send the images to based on additional static data, such as a time period. For example, First REC UCS 1204 could receive images only during a specific time period, could receive images of a certain type (such as letters, flats, parcels, etc.), or could receive images from selected plants, etc. One having skill in the art will also appreciate that each plant need not send its images to more than one REC, and that the encoding center need not be at a remote location.

In certain embodiments, static configuration data may be assigned to images. Static configuration data may include, for example, image source information, such as information regarding which MPE captured the image, or product type information. For example, images corresponding to parcels or to Priority Mail items may be marked for processing before any other types of images. If static configuration data is present, then images are distributed accordingly to a specific encoding device, or coding desk, for processing. An image encoding center determines if, for example, a first and second image has static configuration data. If a first image has static configuration data, the encoding center may select a first video display terminal for processing; if the first image does not have static configuration data, the encoding center may select a different video display terminal, such as a second video display terminal, for processing using dynamic data. For example, if First REC UCS 1204 detects that an image includes static configuration data indicating that an image corresponds to a mailpiece that is Priority Mail, the image may be directed to a specific encoding device such as Universal Coding Desk 1250. If Static configuration data is not present, the REC UCS uses dynamic data, including, for example, plant product type expected turnaround time tables and available encoding resource tables to determine the processing order of a mailpiece image. The REC UCS utilizes the dynamic data to determine the order in which the mailpiece images will be presented for encoding and which encoding device will encode the mailpiece images. For example, dynamic data may include current available resources, such that if every encoding device at one REC UCS, such as First REC UCS 1204, is busy, so images may be sent to a different REC UCS, such as Second REC UCS 1212, that has idle encoding devices. This dynamic transfer of images between RECs may be made while maintaining one plant's images in FIFO order.

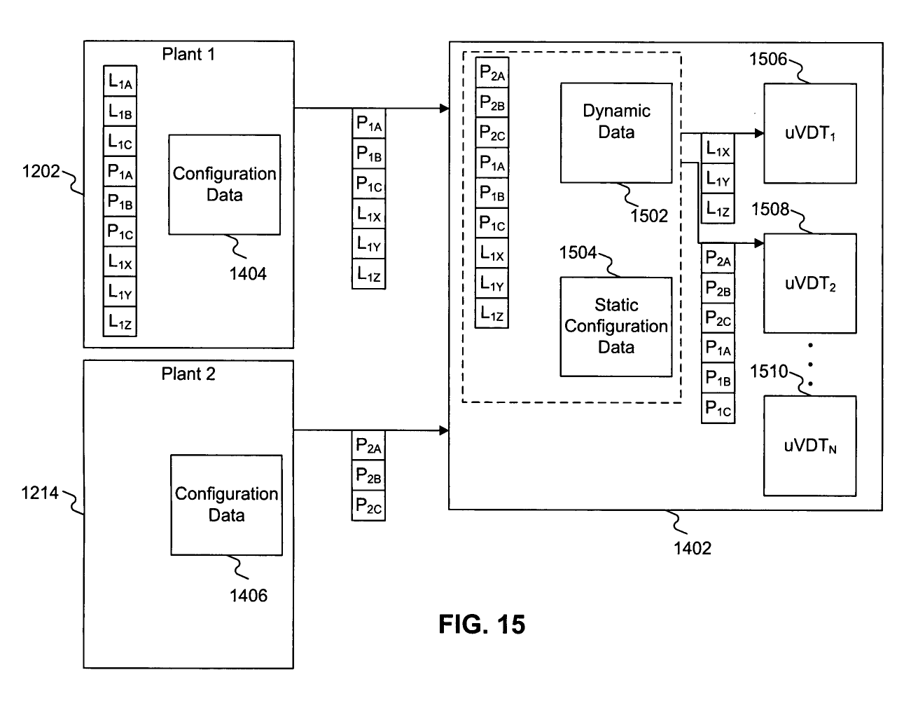

FIG. 15 shows dynamic load balancing within Additional REC UCS 1402 in more detail. In FIG. 15, Additional REC UCS 1402 receives images from First Plant UCS 1202 and Second Plant UCS 1214. Additional REC UCS uses dynamic data 1502 and static configuration data 1504 to determine to which encoding station within Additional REC UCS 1402 images from each mail processing unit should be sent. For example, in FIG. 15, Additional REC UCS 1402 sends images L_{1X}, L_{1Y}, and L_{1Z} received from the Additional Mail Processing Equipment 1210 connected to the First Plant UCS 1202 to Universal Coding Desk 1506. Additional REC UCS 1402 sends images P_{2A}, P_{2B}, and P_{2C} received from the Additional Mail Processing Equipment 1220 connected to the Second Plant UCS 1214 and images P_{1A}, P_{1B}, and P_{1C} received from the Second Mail Processing Equipment 1208 connected to First Plant UCS 1202 to Universal Coding Desk 1508. The uneven distribution of images may be because the REC Operator at Universal Coding Desk 1508 has a higher productivity rate than the REC Operator at Universal Coding Desk 1506 and this is reflected in the dynamic data.

At Universal Coding Desks 1506,1508, and 1510, REC operators view each image and enter address data. The Additional REC UCS 1402 further processes the images by querying information databases using the address data to resolve the image and therefore obtain mail processing data. The results of the encoding processes may then be forwarded back to the originating plant UCS and to the proper mail processing equipment in a similar manner to that shown in FIG. 9. The mailpieces are then processed at the proper mail processing equipment using the mail processing data received from the encoding center, or REC.

Using integrated Load Balancing, encoding devices and resources may be dynamically allocated at the REC UCS based on the expected turnaround times for each MPE, product type, and plant. Therefore, an administrator at a REC UCS or plant UCS may change the dynamic data to manage the workload of the REC operators and the REC as a whole, and integrate and manage the workload of image processing for other products, such as form processing, images of foreign mail, electronic custom manifesting, etc. For example, dynamic data 1502 may include a product type expected turnaround table that may specify how quickly mailpiece images should be processed for a certain mailpiece type based on the MPE handling that type of mailpiece. In yet another example, an administrator at a REC or plant UCS such as First Plant UCS 1202 or Second Plant UCS 1214 may change information stored in the dynamic data to redirect images to Second REC UCS 1212 if First REC UCS 1204 is experiencing technical difficulties or is overloaded. Encoding resources may also be allocated based on the source of the image, e.g., images for a plant or a specific mail processing equipment that is behind in its mail sorting runs may be processed after images for other plants or mail processing equipment.

One having skill in the art will further note that the present invention may not only involve multiple mail processing plants, but that the REC UCS may handle different modes for each plant UCS or each product type. For example, a plant may have a wait mode, which requires the mailpiece images to first go to a reader pool prior to being sent to a REC, a no wait mode, which does not require prior reader pool processing, and an off mode, wherein a plant will not send any mailpieces to the reader pool. Alternately, images of one type of mail, such as letters, may be in no wait mode while images of another type of mail, such as parcels, are in wait mode.

One having skill in the art will also note that when images are sent to more than one REC, a first REC determines if a first image has static configuration data and selects a first video display terminal for processing the first image if static configuration data is present. If static configuration data is not present, the first REC uses first dynamic data comprising productivity data to select a second video display terminal for processing the first image. The first image is then processed to create first item processing data, and the first item processing data is sent to a coding system, and then sent to a first mail processing device, where a first delivery item is sorted using the first item processing data. A second REC may further check a second image for static configuration data, select a third video display terminal for processing an image if static configuration data is present, or use second dynamic data comprising productivity data to select a fourth video display terminal for processing the second image if static configuration is not present. The second image is then processed to create second item processing data, and the second item processing data is sent to a coding system, and then sent to a second mail processing device, where the second delivery item is sorted using the second item processing data.

Although the foregoing text describes systems and methods for processing mail, embodiments of the present invention may be applied to systems and methods for processing other delivery items as well. For example, using systems and methods consistent with the invention, forms may be sorted, processed, and delivered using one or more codes, such as bar codes, printed on the forms. One skilled in the art will recognize that other delivery items could also be processed and delivered using methods and systems consistent with the universal coding system disclosed herein.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for processing mailpieces, comprising:
capturing images of mailpieces processed by a first mail processing device and a second mail processing device;
storing the images in a coding system at a mail processing plant;
sorting the images at the coding system according to time characteristics;
transmitting the images from the mail processing plant to a remote location;
processing the images at an encoding center at the remote location in the sorted order to obtain mail processing data from the images;
transmitting the mail processing data from the encoding center to the mail processing plant; and
processing the mailpieces by the first mail processing device and the second mail processing device using the mail processing data from the encoding center.

2. The method of claim 1, wherein the time characteristics comprise image capture times.

3. The method of claim 1, wherein the time characteristics comprise image receipt times.

4. The method of claim 1, wherein the mailpieces processed by the first mail processing device are of a different type than the mailpieces processed by the second mail processing device.

5. The method of claim 1, wherein the mailpieces comprise at least one of flats, letters, bundles, parcels, or forms.

6. The method of claim 1, wherein the images are captured only if the mailpieces cannot be processed mechanically by the first mail processing device and the second mail processing device.

7. The method of claim 1, wherein the coding system comprises a Universal Coding System.

8. The method of claim 1, wherein storing the images comprises storing additional data along with the images.

9. The method of claim 8, wherein the additional data comprises at least one of an identification tag, an image source, an image product type, or an image age.

10. The method of claim 1, wherein the storing the images comprises keeping a count of images sent to the encoding center.

11. The method of claim 1, wherein sorting the images uses First In First Out processing.

12. The method of claim 1, wherein sorting the images uses Last In First Out processing for at least a portion of the images.

13. The method of claim 1, comprising:
creating coding strategies for the images at the coding system.

14. The method of claim 13, comprising:
transmitting the coding strategies by the mail processing plant to the encoding center.

15. The method of claim 1, wherein the images are transmitted to the remote location over a network.

16. The method of claim 1, wherein processing the mailpieces by the first mail processing device and the second mail processing device is performed subsequent to receiving a request from the first mail processing device and the second mail processing device for the mail processing data at the mail processing plant.

17. The method of claim 1, wherein processing the images comprises inputting mailpiece address data.

18. The method of claim 17, wherein the mailpiece address data comprises at least one of a ZIP™ Code, a street address, a city or a state.

19. The method of claim 1, comprising:
distributing the images to operators at the encoding center based on priority data.

20. The method of claim 1, wherein processing the images utilizes Universal Coding Desks capable of processing images from multiple mail processing devices.

21. The method of claim 1, wherein processing the images comprises querying an address information database.

22. The method of claim 1, wherein the mail processing data comprises a numerical code.

23. The method of claim 1, wherein the mail processing data comprises at least one of a delivery point code, a ZIP™ Code, or a POSTNET code.

24. A method for processing mailpieces, comprising:
capturing images of mailpieces processed by a first mail processing device;
storing the images in a coding system at a mail processing plant;
sorting the images at the coding system according to time characteristics;
transmitting the images from the mail processing plant to a remote location;
processing the images at an encoding center at the remote location in the sorted order to obtain mail processing data from the images;
transmitting the mail processing data from the encoding center to a second mail processing device at the mail processing plant; and
processing the mailpieces by the second mail processing device using the mail processing data from the encoding center.

25. A method for processing mailpieces, comprising:
capturing images of mailpieces processed by a first mail processing device;
storing the images in a coding system at a first mail processing plant;
sorting the images at the coding system according to time characteristics;
transmitting the images from the first mail processing plant to a remote location;
processing the images at an encoding center at the remote location in the sorted order to obtain mail processing data from the images;
transmitting the mail processing data from the encoding center to a second mail processing device at a second mail processing plant; and
processing the mailpieces by the second mail processing device using the mail processing data from the encoding center.

26. A method for processing mailpieces, comprising:
capturing images of mailpieces processed by a mail processing device;
storing the images in a coding system at a mail processing plant;
sorting the images at the coding system to be in a First In First Out order;
transmitting the images from the mail processing plant to an encoding center;
processing the images at the encoding center in the sorted order to obtain mail processing data from the images;
transmitting the mail processing data from the encoding center to the mail processing plant; and
processing the mailpieces by the mail processing device using the mail processing data from the encoding center.

27. A method for processing mailpieces, comprising:
receiving images of mailpieces at a coding system, wherein the images are captured by a mail processing device;
storing the images at the coding system;
sorting the images according to time characteristics at the coding system;
transmitting the images from the mail processing plant to an encoding center for processing, wherein the images are processed at the encoding center to obtain mail processing data;
receiving the mail processing data from the encoding center;
transmitting the mail processing data to the mail processing device; and
processing the mailpieces using the mail processing data at the mail processing device.

28. A method for processing images of delivery items, comprising the steps of:
capturing a first image of a first delivery item to be processed at a first mail processing device;
capturing a second image of a second delivery item to be processed at a second mail processing device;
sending the first image and the second image to a coding system;
receiving the first image and the second image at the coding system;
sorting the first image and the second image according to time characteristics of the images;
subsequent to sorting the first image and the second image, sending the first image and the second image to a remote image encoding center;
receiving the first image and the second image at the remote image encoding center;
processing the first image at the image encoding center to obtain first item processing data;
processing the image of the second item at the image encoding center to obtain second item processing data;
sending the first item processing data and the second item processing data from the image encoding center to the coding system;
sending the first item processing data from the coding system to the first mail processing device;
sending the second item processing data from the coding system to the second mail processing device;
sorting the first delivery item using the first item processing data; and
sorting the second delivery item using the second item processing data.

29. A system for processing mailpieces, comprising:
a first mail processing device for sorting mailpieces, for capturing images of unresolved mailpieces when the unresolved mailpieces cannot be sorted, and for transmitting the images;
a second mail processing device for sorting mailpieces, for capturing images of unresolved mailpieces when the unresolved mailpieces cannot be sorted, and for transmitting the images;
a coding system at a mail processing plant for receiving the images from the first mail processing device and the second mail processing device, sorting the images according to time characteristics of the images, and transmitting the images; and
an encoding center located at a location remote from the mail processing plant for receiving the images, determining mail processing data using the images, and transmitting the mail processing data to the coding system.

30. The system of claim 29, wherein the time characteristics comprise image capture times.

31. The system of claim 29, wherein the time characteristics comprise image receipt times.

32. The system of claim 29, wherein the first mail processing device sorts a first type of mailpieces and the second mail processing device sorts a second type of mailpieces.

33. The system of claim 29, wherein the mailpieces comprise at least one of flats, letters, bundles, parcels, or forms.

34. The system of claim 29, wherein the coding system comprises a Universal Coding System.

35. The system of claim 29, wherein the coding system creates a sorting order using First In First Out processing.

36. The system of claim 29, wherein the coding system creates a sorting order using Last In First Out processing for at least a portion of the images.

37. The system of claim 29, wherein the coding system is coupled to the encoding center over a network.

38. The system of claim 29, wherein the first mail processing device and the second mail processing device send requests for the mail processing data to the coding system.

39. The system of claim 29, wherein the encoding center comprises a Universal Coding Desk capable of processing images from multiple mail processing devices.

40. The system of claim 29, wherein the encoding center communicates with an address information database.

41. The system of claim 29, wherein the mail processing data comprises a numerical code.

42. The system of claim 29, wherein the mail processing data comprises a delivery point code.

43. The system of claim 29, wherein the mail processing data comprises a ZIP™ Code.

44. The system of claim 29, wherein the mail processing data comprises a POSTNET code.

45. The system of claim 29, comprising a second encoding center for receiving at least a portion of the images.

46. The system of claim 29, comprising a second mail processing plant for receiving the images from the first mail processing device and the second mail processing device, sorting the images according to configuration data, and transmitting the images.
